(19) United States
(12) Patent Application Publication
(10) Pub. No.: US 2005/0262981 A1
(43) Pub. Date: Dec. 1, 2005

(54) Cutting device for cutting in quarters food products and other products

(75) Inventor: Antonio Turatti, Cavarzere (VE) (IT)

Correspondence Address: YOUNG & THOMPSON, 745 SOUTH 23RD STREET, 2ND FLOOR, ARLINGTON, VA, 22202, US

(73) Assignee: TURATTI S.R.L., CAVARZERE (IT)

(21) Appl. No.: 11/138,415

(22) Filed: May 27, 2005

(30) Foreign Application Priority Data
May 28, 2004 (IT) RM2004A000263

(51) Int. Cl. B26D 7/06

(52) U.S. Cl. 83/404; 83/418; 83/435.2

(57) ABSTRACT

The invention relates to a cutting device for cutting in quarters food products and other products, comprising a product centring group, a longitudinal cutting group and a quarters cutting group, said product centring group providing means receiving the product fed and means for centring the same product to prepare the same for cutting, said longitudinal cutting group providing longitudinal cutting blades, and said quarters cutting group providing a multiple blades cutting head.

The present invention relates to a cutting device for cutting in quarters food products and other products.

More specifically, the invention concerns a device of the above kind allowing cutting food products and other products, having a lengthened shape, in quarters or slices obtained from the quarters of the product.

Automatic working of food products, particularly for food industry, and still more for working food products, has determined in the recent years the development of a remarkable number of more or less automatic apparatuses, for working these products.

Particularly, when working some specific products, it is necessary cutting the products in quarters or slices deriving from the quarters.

In this context it is included the solution according to the present invention, suggesting a shearing machine for cutting in quarters food products and other products.

It is therefore specific object of the present invention a cutting device for cutting in quarters food products and other products, comprising a product centring group, a longitudinal cutting group and a quarters cutting group, said product centring group providing means receiving the product fed and means for centring the same product to prepare the same for cutting, said longitudinal cutting group providing longitudinal cutting blades, and said quarters cutting group providing a multiple blades cutting head.

Preferably, according to the invention, said product centring group provides two lower feeding, long powered belts, on which the product is automatically fed, two upper, short powered belts for laterally containing the product, a centring group, comprised of a quadrilateral, made up of eight universal joints, and four plates integral with the structure supporting the whole centring system.

Particularly, a rod is pivoted on each branch of the universal joint, said rod being hinged at one end on a cylindrical guide, fixed to a long belt or to a short belt, and on the other side maintained in position by a spring.

According to the invention, for each displacement of a belt caused by the passage of the product, the rod finds a new balancing position sliding along the cylindrical guide, said sliding causing a rotation of the universal quadrilateral, evenly distributed on the four belts, so that the system reaches a new equilibrium condition, remaining aligned along the cutting axis, said spring helping in making the four belts returning in the closure position.

Furthermore, according to the invention, the longitudinal cutting group can be comprised of four blades rotating according to the product rotation direction, said blades being fixed in a central position among the four short belts in the final position.

Always according to the invention, said cutting group can be comprised of four fixed blades provided in a central position between the four short belts.

Still according to the invention, said quarters cutting group is provided at the outlet of the four short belts, and immediately after the longitudinal cut, and it provides a plural blade cutting head allowing making a second cut, and particularly cutting the product already cut in quarters in further segments.

The present invention will be now described, for illustrative but not limitative purposes, according to its preferred embodiments, with particular reference to the figures of the enclosed drawings, wherein:

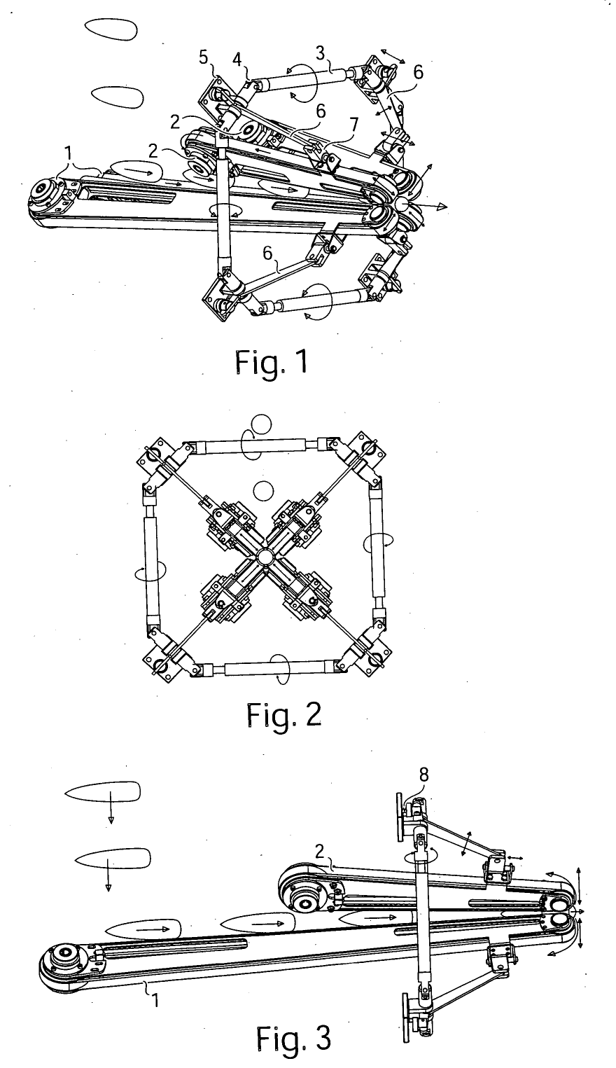

FIG. 1 is a perspective view of the product centring group of a cutting device according to the invention;

FIG. 2 is a view of the centring group of FIG. 1 in a closed position;

FIG. 3 is an enlarged view of the centring group of FIG. 1;

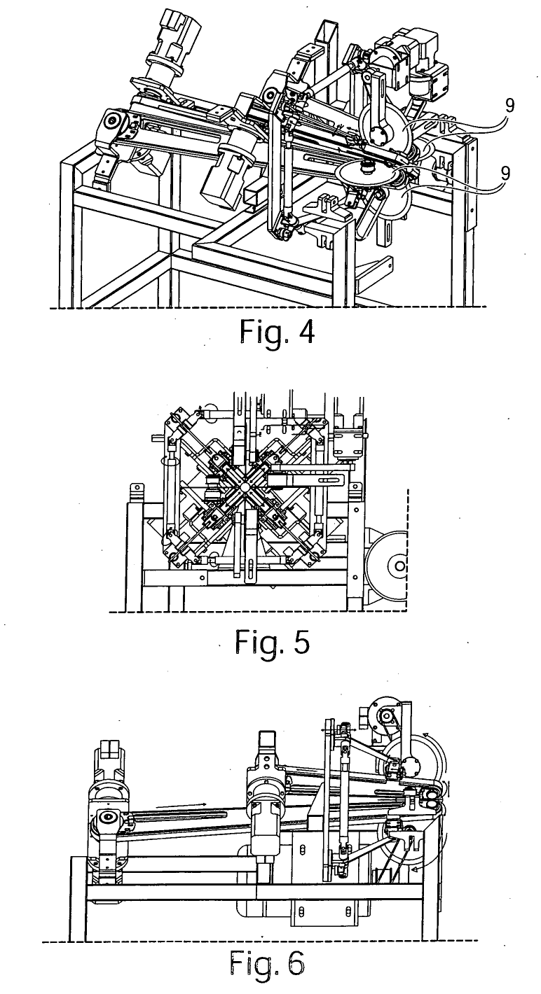

FIG. 4 is a perspective view of the longitudinal cutting group of a cutting device according to the invention;

FIG. 5 is a view of the longitudinal cutting group of FIG. 4 in a closed position;

FIG. 6 is an enlarged view of the centring group of FIG. 4;

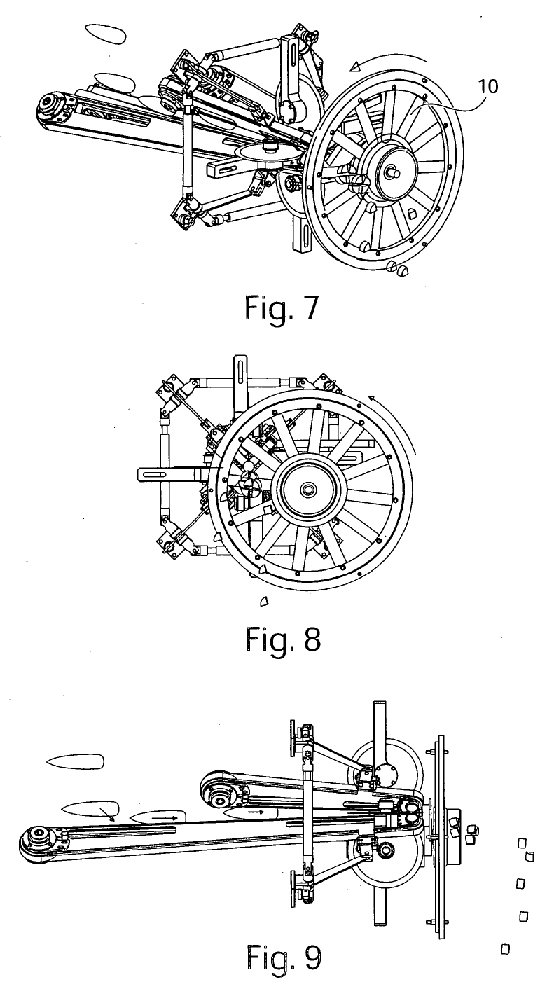

FIG. 7 is a perspective view of the quarters cutting group according to the invention;

FIG. 8 is a front view of the quarters cutting group of FIG. 7; and

FIG. 9 is a lateral view of the quarters cutting group of FIG. 7.

Observing now the figures of the enclosed drawings, it is shown a cutting device according to the invention realised for cutting food products and other products, having an irregular lengthened shape, in quarters or slices obtained from quarters.

As it can be noted from the figures, said cutting device is comprised of three different groups:
a) product centring group (shown in FIGS. 1-3);
b) longitudinal cutting group (shown in FIGS. 4-6);
c) slice cutting group (shown in FIGS. 7-9).

Referring first to FIGS. 1-3 of the enclosed drawings, it is shown the centring group aiming at maintaining aligned the axis of the product with respect to the quarters cutting axis.

Cutting device comprises four blades, linked on a single central axis used as quarters cutting axis.

Said product centring group provides two lower feeding, long powered belts 1, on which the product is automatically fed, two upper, short powered belts 2 for laterally containing the product, a centring group, comprised of a quadrilateral, made up of eight universal joints 4, and four plates 5 integral with the structure supporting the whole centring system.

A rod 6 is pivoted on each branch of the universal joint 4, said rod 6 being hinged at one end on a cylindrical guide 7, fixed to a long belt 1 or to a short belt 2, and on the other side maintained in position by a spring 8.

For each displacement of a belt 1 or 2 caused by the passage of the product, the rod 6 finds a new balancing position sliding along the cylindrical guide 7, said sliding causing a rotation of the universal quadrilateral 3, evenly distributed on the four belts. Consequently, the system reaches a new equilibrium condition, remaining aligned along the cutting axis.

The four springs 8 help in making the four belts returning in the closure position.

Coming now to observe FIGS. 4-6, it is shown the longitudinal cutting group, comprised of four blades 9 rotating according to the product rotation direction.

Said blades 9 are fixed in a central position among the four short belts 2 in the final position.

In place of the blade 9, it is possible providing four fixed blades provided in a central position between the four pressure belts 2. This embodiment is particularly suitable for very tender products, such as cucumbers and zucchinis.

Observing now FIGS. 7-9, it is shown the quarters cutting group, provided at the outlet of the four alignment/pressure belts 2, and immediately after the longitudinal cut. It provides a plural blade cutting head 10, allowing making a second cut, and particularly cutting the product already cut in quarters in further segments.

Thickness of the cut varies in function of the cutting speed, of the number of blades, and of the alignment/pressure belts.

The present invention has been described for illustrative but not limitative purposes, according to its preferred embodiments, but it is to be understood that modifications and/or changes can be introduced by those skilled in the art without departing from the relevant scope as defined in the enclosed claims.

1. Cutting device for cutting in quarters food products and other products, characterised in that it comprises a product centring group, a longitudinal cutting group and a quarters cutting group, said product centring group providing means receiving the product fed and means for centring the same product to prepare the same for cutting, said longitudinal cutting group providing longitudinal cutting blades, and said quarters cutting group providing a multiple blades cutting head.

2. Cutting device for cutting in quarters food products and other products, according to claim 1, characterised in that said product centring group provides two lower feeding, long powered belts, on which the product is automatically fed, two upper, short powered belts for laterally containing the product, a centring group, comprised of a quadrilateral, made up of eight universal joints, and four plates integral with the structure supporting the whole centring system.

3. Cutting device for cutting in quarters food products and other products, according to claim 2, characterised in that a rod is pivoted on each branch of the universal joint, said rod being hinged at one end on a cylindrical guide, fixed to a long belt or to a short belt, and on the other side maintained in position by a spring.

4. Cutting device for cutting in quarters food products and other products, according to claim 2, characterised in that, for each displacement of a belt caused by the passage of the product, the rod finds a new balancing position sliding along the cylindrical guide, said sliding causing a rotation of the universal quadrilateral, evenly distributed on the four belts, so that the system reaches a new equilibrium condition, remaining aligned along the cutting axis, said spring helping in making the four belts returning in the closure position.

5. Cutting device for cutting in quarters food products and other products, according to claim 1, characterised in that the longitudinal cutting group can be comprised of four blades rotating according to the product rotation direction, said blades being fixed in a central position among the four short belts in the final position.

6. Cutting device for cutting in quarters food products and other products, according to claim 1, characterised in that said cutting group is comprised of four fixed blades provided in a central position between the four short belts.

7. Cutting device for cutting in quarters food products and other products, according to claim 1, characterised in that said quarters cutting group is provided at the outlet of the four short belts, and immediately after the longitudinal cut, and it provides a plural blade cutting head allowing making a second cut, and particularly cutting the product already cut in quarters in further segments.

8. (canceled)

9. Cutting device for cutting in quarters food products and other products, according to claim 3, characterised in that, for each displacement of a belt caused by the passage of the product, the rod finds a new balancing position sliding along the cylindrical guide, said sliding causing a rotation of the universal quadrilateral, evenly distributed on the four belts, so that the system reaches a new equilibrium condition, remaining aligned along the cutting axis, said spring helping in making the four belts returning in the closure position.
